(19) United States
(12) Patent Application Publication
(10) Pub. No.: US 2006/0070931 A1
(43) Pub. Date: Apr. 6, 2006

(54) Method for determining performance values, which refer to multiple withdrawals, of a sorting machine and of a detector for detecting these multiple withdrawals

(75) Inventor: Andre Rompe, Berlin-Kaulsdorf (DE)

Correspondence Address: SIEMENS SCHWEIZ;I-44, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 10/547,923

(22) PCT Filed: Feb. 17, 2004
(86) PCT No.: PCT/EP04/01461

§ 371 Date: Sep. 7, 2005

(30) Foreign Application Priority Data
Mar. 11, 2003 (DE) 103 10 546.8

(51) Int. Cl. B07C 5/00

(52) U.S. Cl. 209/584; 209/900

(57) ABSTRACT

Firstly, a fan sorting pass is carried out during which a postal article, which is removed from a stack, or a multiple withdrawal is to be distributed one after another in m, m=1 passes at P sorting terminals of the sorting machine. The number m of passes is selected according to the required precision. Afterwards, both the number N_{AD} of multiple withdrawals measured by the detector and the number N_{AS} of the individual withdrawals measured by the detector are determined as well as the number N_{SD} of incorrectly detected individual withdrawals and the number N_{DS} of incorrectly detected multiple withdrawals by comparing the number of the postal articles, which are located in each involved sorting terminal, with the measuring result of the detector, said measuring result being assigned to the respective sorting terminal.

The invention relates to a method for determining performance values, which refer to multiple withdrawals, of a sorting machine and of a detector for detecting these multiple withdrawals.

The publications JP 2002 239 471 AA and JP 2002 239 471 A disclose sorting machines exhibiting a withdrawal device for separating flat postal articles from a stack, a detector for detecting multiple withdrawals, a rejection terminal for multiple withdrawals, a device for determining address information and with sorting terminals. With the conventional mode of operation of sorting machines of this type, postal articles are withdrawn one after another from the postal article stack by means the withdrawal device, and directed to the detector to detect overlappings, detected double withdrawals are fed into the rejection terminal and the remaining postal articles are forwarded into the sorting terminal on the basis of the detected address information. In this case, a sorting terminal can generally receive a number of postal articles which are withdrawn in several withdrawal processes and are specific to the same destination location.

Corresponding detectors have hitherto been known which determine overlappings related to different measuring principles, provoked by multiple withdrawals of the separation device.

DE 43 37 004 A1 describes a device and a method for detecting overlappings of flexible flat postal articles, with which at least one segment of each postal article can be moved perpendicular to the conveying direction in the transportation section. At least one deflection element is disposed on the transportation section, through which the moveable postal article segments perpendicular to the conveying direction are temporarily deflected by a predetermined amount during the conveying in the transportation section. In a detection direction, the presence of overlapping postal article segments is detected on the basis of the repulsion behavior of the postal articles.

With a further solution (DE 196 25 044 A1) an overlapping is reported using optical measuring means for the height of the postal article if a height jump is detected when the postal articles are passing through the optical measuring system and the height measurement is repeated.

No statements were made in the mentioned publications with reference to the performance data of the detectors to detect overlappings and to determine the performance data in the sorting machines.

The object underlying the invention is to create a low-cost method for the exact determination of performance values, which refer to multiple withdrawals, of a sorting machine and or a detector for detecting these multiple withdrawals.

The object is achieved according to the invention by means of a method with the features of claim 1.

Firstly, a fan sorting pass is carried out with m, m≧1, passes. In each pass, P consecutive withdrawals are carried out by means of a withdrawal device from a postal article stack of flat postal articles. For each withdrawal, the presence of an individual withdrawal or of a multiple withdrawal is determined by means of a detector for detecting multiple withdrawals in each instance, and the respectively withdrawn postal article quantity is forwarded into one of P empty sorting terminals. The number N_{SD} (m) of the total number of separate withdrawals detected incorrectly in this pass as multiple withdrawals and the number N_{DS} (m) of multiple withdrawals detected incorrectly in this pass as individual withdrawals is then detected, in which for each of the P sorting terminals involved, the number of postal articles located therein is compared with the measuring result of the detector. For the N withdrawals carried out in total in the m passes with the respective P withdrawals, the number N_{AD} of the multiple withdrawals established with the detector and the number N_{AS} of the individual withdrawals determined by the detector is determined. The number N_{SD} of the total number of incorrectly detected individual withdrawals and the number N_{DS} of the total number or incorrectly detected multiple withdrawals is determined by adding up the values N_{SD} (m) and/or N_{DS} (m). The performance values are finally calculated from the determined values N_{AD}, N_{AS}, N_{SD}, N_{DS}. The number m of passes is selected according to the required precision.

The method allows the performance data to be controlled in the course of the sorting operation, in which fan sorting passes are carried out at defined intervals between the normal sorting passes, and subsequently the further method steps described are implemented.

Advantageous embodiments of the invention are set down in the subclaims.

It is thus advantageous to calculate a multiple withdrawal rate DFR according to the following formula:

$$DFR [ \% ] = \frac{{N}_{D}}{N} * 100 = \frac{{N}_{AD} - {N}_{SD} + {N}_{DS}}{{N}_{AD} + {N}_{AS}} * 100$$

This produces a variable characterizing the separation device of the respective sorting machine which allows for the fault measurements.

It is also advantageous to calculate a detection rate DR according to the following formula:

$$DR [ \% ] = \frac{{N}_{DD}}{{N}_{D}} * 100 = \frac{{N}_{AD} - {N}_{SD}}{{N}_{AD} - {N}_{SD} + {N}_{DS}} * 100$$

This variable specifies the probability of a correct measurement of a multiple withdrawal as a feature characterizing the quality of the detector.

Furthermore, it is advantageous to calculate an error rate ER according to the following formula:

$$ER [ \% ] = \frac{{N}_{SD}}{{N}_{S}} * 100 = \frac{{N}_{SD}}{{N}_{AS} - {N}_{DS} + {N}_{SD}} * 100$$

This variable describes the relative number of faulty postal articles identified as multiple withdrawals, and thus characterizes the performance from the standpoint of faults.

The invention is described in more detail below with reference to the drawing, in which;

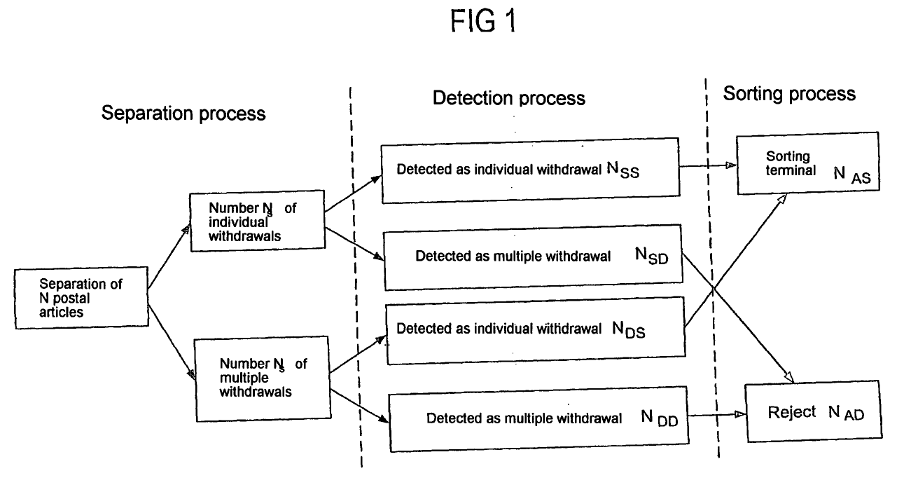

FIG. 1 shows a process model for the sorting process during the use of a device for detecting overlappings during the separation of flat postal articles.

The process model for the sorting process with the use of a device for detecting overlappings during the separation of flat postal articles according to FIG. 1 serves to improve the understanding of the operation with the separation of the postal articles as well as with the detection of overlappings and with subsequent sorting.

In the separation process with P separations in the sorting operation, both a number N_{S} of individual withdrawals and also a number N_{D} of multiple withdrawals/overlappings (mainly double withdrawals) occur. In the case of the detection process during the normal sorting process, a number N_{DD} of overlappings is correctly detected on the one hand and routed to a so-called rejection terminal and on other hand a number N_{DS} of overlappings is not detected which are then routed incorrectly into normal sorting terminals.

A number N_{SS} of the actual N_{S} individual withdrawals is correctly detected and is transported into the associated sorting terminals. At the same time, a number N_{SD} of individual withdrawals is incorrectly detected as an overlapping and is transported to the rejection terminal. To obtain the performance data of a corresponding detector, the frequency of the different error detections and/or the correct detection are statistically determined. The following values were established as performance data:

$$\begin{matrix}1. & Overlapping rate DFR [ \% ] = \frac{{N}_{D}}{N} * 100 with N = {N}_{D} + {N}_{S} \\ 2. & Detection rate DR [ \% ] = \frac{{N}_{DD}}{{N}_{D}} * 100 with {N}_{D} = {N}_{DD} + {N}_{DS} \\ 3. & Error rate ER [ \% ] = \frac{{N}_{DD}}{{N}_{S}} = \frac{{N}_{SD}}{{N}_{S}} * 100 with {N}_{S} = {N}_{SS} + {N}_{SD}\end{matrix}$$

The number of postal articles sorted in the rejection terminal and thus the number N_{AD} of the apparent multiple withdrawals results from the relationship N_{AD}=N_{DD}+N_{SD} and the number of the apparent individual withdrawals NAS from the relationship N_{AS}=N_{SS}+N_{DS}.

With the aid of these relationships, the following describes how the performance data of an overlapping detector can be exactly determined.

The overlapping detector is, in this case, equipped with a software which supports the following method sequence:
1. Set the detector in the mode to determine the performance data
2. Carry out a fan sorting pass, in which each postal article and/or multiple withdrawal is sorted from a stack in the case of the consecutive sorting terminals on top of each other.
3. Determine the number of postal articles located in the each sorting terminal and empty the sorting terminals.

4. Determine the number N_{AD} of multiple withdrawals, overlappings measured with the detector and the number N_{AS} of individual withdrawals measured with the detector.
5. Determine the number N_{SD} of incorrectly detected individual withdrawals and the number N_{DS} of incorrectly detected multiple withdrawals, overlappings by comparing the number of postal articles located after the fan sorting pass in each sorting terminal with the measuring result of the detector assigned to the respective sorting terminal.
6. According to the required precision, implementation of further sorting passes and adding up of values determined according to point 4 and 5.
7. Calculate the overlapping rate DFR, the detection rate DR and the error rate ER from the total values determined from the corresponding point 4 and 5 according to the relationships:

$$\begin{matrix}DFR [ \% ] = \frac{{N}_{AD} + {N}_{DS} - {N}_{SD}}{{N}_{AD} + {N}_{AS}} * 100 \\ DR [ \% ] = \frac{{N}_{AD} - {N}_{SD}}{{N}_{AD} - {N}_{SD} + {N}_{DS}} * 100 \\ ER [ \% ] = \frac{{N}_{SD}}{{N}_{AS} - {N}_{DS} + {N}_{SD}} * 100\end{matrix}$$

In the following table 1, the result of a fan sorting pass is displayed for example with one pass using P=15 sorting terminals, in which the flat postal articles are sorted. In the case of the fan sorting pass, the first withdrawal is sorted at the beginning in the sorting terminal 1, then the second withdrawal in the sorting terminal 2 and/or until the fifteenth withdrawal is finally routed into the sorting terminal 15. In this case, a withdrawal can consist of both an individual postal article with an individual withdrawal and also of several overlapping postal articles in the case of an erroneous withdrawal.

TABLE 1

| | Terminal No. | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Detector result | S | D | S | S | D | S | S | D | S | S | S | S | S | S | D |
| Correct/incorrect | C | I | C | C | C | C | C | I | C | C | I | C | C | C | C |

S = Individual withdrawal,
D = Multiple withdrawal,
C = correct,
I—Incorrect

The majority of detection results are correct, but some appeared to be incorrect during the comparison with the contents of the sorting terminals.

The 15 terminals are implemented in the first line, the detector results assigned to the sorting terminals in the second line, and the examination result and content of the respective sorting terminal in the third line.

In this case, the result is as follows:

The detector has measured an overlapping/multiple withdrawal for the sorting terminals 2, 5, 8 and 15. The examination shows that this is not aligned to sorting terminals 2 and 8, since only individual postal articles were available there. On the other hand, an individual withdrawal was detected for the sorting terminal 11, although two overlapping postal articles were located there.

The following values thus emerge:

| | |
|---|---|
| N_{AD} = | 4 |
| N_{AS} = | 11 |
| N_{SD} = | 2 |
| N_{DS} = | 1 |

This results in an overlapping rate:

$$DFR [ \% ] = \frac{{N}_{AD} - {N}_{SD} + {N}_{DS}}{{N}_{AD} + {N}_{AS}} *= \frac{4 - 2 + 1}{4 + 11} * 100 = 3 / 15 * 100 = 20 \%$$

a detection rate:

$$DR [ \% ] = \frac{{N}_{AD} - {N}_{SD}}{{N}_{AD} - {N}_{SD} + {N}_{DS}} * 100 = \frac{4 - 2}{4 - 2 + 1} * 100 = 2 / 3 * 100 = 66.6 \%$$

and an error rate

$$ER [ \% ] = \frac{{N}_{SD}}{{N}_{AS} - {N}_{DS} + {N}_{SD}} * 100 = \frac{2}{11 - 1 + 2} * 100 = 1 / 6 * 100 = 16.6 \%$$

1. A method for determining performance values of multiple withdrawals of a sorting machine and of a detector for detecting the multiple withdrawals, the method comprising the steps of:
a) carrying out a fan sorting pass with m≧1 and in each pass of the fan sorting pass,
a1) carrying out P consecutive withdrawals from a postal article stack of flat postal articles by means of a withdrawal device,
a2) establishing a presence of an individual withdrawal or a multiple withdrawal for each withdrawal by means of a detector arranged to detect multiple withdrawals,
a3) forwarding a withdrawn postal article quantity into an empty sorting terminal P for each withdrawal,
a4) determining a number N_{SD} (m) of individual withdrawals incorrectly detected in a pass as multiple withdrawals and a number N_{DS} (m) of multiple withdrawals detected incorrectly in a pass as individual withdrawl, in which for each of the involved P sorting terminals, a number of postal articles located therein is compared with a measuring result of the detector,
b) determining for N withdrawals carried out in total in m passes with a respective P withdrawals, a number N_{AD} of multiple withdrawals and a number N_{AS} of individual withdrawals, using the detector,
c) determining a number N_{SD} of a total number of incorrectly detected individual withdrawals and a number N_{DS} of a total number of incorrectly detected multiple withdrawals by adding up at least one of the numbers N_{SD} (m) and N_{DS} (m), and
d) and calculating performance values from the values N_{AD}, A_{AS}, N_{SD} and N_{DS} determined in steps b) and c).

2. The method according to claim 1, wherein a multiple withdrawal rate DFR is calculated from the actual number N_{D} of multiple withdrawals as the performance value for the withdrawal device and the number N of all implemented withdrawals is calculated according to the following equation:
$$DFR [ \% ] \frac{{N}_{D}}{N} * 100 = \frac{{N}_{AD} - {N}_{SD} + {N}_{DS}}{{N}_{AD} + {N}_{AS}} * 100$$

3. The method according to claim 1, wherein a detection rate DR is calculated from the number N_{DD} of correctly detected multiple withdrawals as a performance value for the detector and the actual number N_{D} of multiple withdrawals, according to the following equation:
$$DR [ \% ] = \frac{{N}_{DD}}{{N}_{D}} * 100 = \frac{{N}_{AD} - {N}_{SD}}{{N}_{AD} - {N}_{SD} + {N}_{DS}} * 100$$

4. The method according to claim 1, further comprising the step of calculating an error rate ER from the number N_{SD} of the individual withdrawals detected incorrectly as multiple withdrawals as the performance value for the detector, and the actual number N_{S} of individual withdrawals is calculated according to the following equation:
$$ER [ \% ] = \frac{{N}_{SD}}{{N}_{S}} * 100 = \frac{{N}_{SD}}{{N}_{AS} - {N}_{DS} + {N}_{SD}} * 100$$
